(19) United States
(12) Patent Application Publication
(10) Pub. No.: US 2026/0233268 A1
(43) Pub. Date: Aug. 13, 2026

(54) METHOD FOR THE SEPARATION AND RECOVERY OF PLASTICS AND CONTAMINANTS THROUGH MULTI-STAGE SEPARATION PROCESS

(71) Applicant: Thomas A Valerio, ATLANTA, GA (US)

(72) Inventor: Thomas A Valerio, ATLANTA, GA (US)

(21) Appl. No.: 19/639,164

(22) Filed: Apr. 4, 2026

Related U.S. Application Data
(63) Continuation of application No. PCT/US2024/050856, filed on Oct. 10, 2024.
(60) Provisional application No. 63/543,485, filed on Oct. 10, 2023.

(51) Int. Cl. B09B 3/35; B03B 9/06; B03C 1/30; B03C 7/00; B07B 1/00; B09B 101/05; B09B 101/75; B09B 101/80

(52) U.S. Cl. CPC B09B 3/35; B03B 9/06; B03C 1/30; B03C 7/003; B07B 1/00; B03C 2201/20; B07B 2220/02; B09B 2101/05; B09B 2101/75; B09B 2101/80

(57) ABSTRACT

Methods and systems presented herein are designed for processing waste material to extract plastics. An system and method for separating and recovering plastics from mixed waste feedstock are disclosed. The process involves initial size reduction, moisture removal, and sequential sink-float density separation at different specific gravities to separate low-density plastics such as polypropylene (PP) and polyethylene (PE) from denser materials like acrylonitrile butadiene styrene (ABS) and polystyrene (PS). The system is adaptable to various waste streams and feedstock compositions.

### STATEMENT OF RELATED PATENT APPLICATIONS

This is application a continuation of International Patent Application No. PCT/US2024/050856, filed on Oct. 10, 2024, claims the benefit of U.S. Provisional Patent Application No. 63/543,485, filed Oct. 10, 2023, which is incorporated by reference herein in its entirety.

### TECHNICAL FIELD

This application relates to systems and methods relates to a method for the separation and recovery of plastics from a mixed feedstock containing various materials, including ferrous metals, non-ferrous metals, and a range of plastics.

### BACKGROUND

The recycling of plastics offers several advantages compared to producing new, or virgin, plastic from petroleum. Typically, the process of manufacturing products from recycled plastic, sourced from post-consumer and post-industrial waste as well as plastic scrap (hereafter collectively referred to as “waste plastic material”), requires less energy than creating similar products from virgin plastic. Additionally, recycling plastics eliminates the necessity of disposing of plastic materials or products. It also conserves limited natural resources, such as petroleum and polymers, which are otherwise expended in the production of virgin plastic materials.

Recycling of waste materials is increasingly recognized as essential for both economic and environmental reasons. Recyclables, once properly sorted, can often be sold for substantial profit. Many valuable recyclables do not decompose quickly, making their recycling crucial in alleviating pressure on local landfills and, by extension, the broader environment.

A significant challenge in the segregation of different types of plastics arises from their similar densities. This similarity can lead to the gravity separation stage producing a product stream that, for instance, comprises two primary and four secondary types of plastics. Achieving complete purification through subsequent separation methods, such as electrostatic separation, is often complicated due to the diversity and multitude of plastic types and grades involved.

A significant portion of plastics produced by modern manufacturers ends up in landfills or incinerators, largely due to the lack of economically viable recovery technologies. Durable goods like automobiles, appliances, and electronics contribute to over one-third of the plastics in municipal waste. There is a growing trend to collect and partially recycle these goods at the end of their lifespan to minimize disposal costs, mitigate potential liabilities, and salvage metals and other valuable raw materials.

The composition of automobile shredder residue (ASR) and electronic waste shredder residue (ESR) is highly varied, including rubber, wood, metals, wires, circuit boards, foam, glass, and other non-plastic materials. For effective recycling of plastics, these materials must be segregated into distinct product and byproduct streams. Recycling processes must be adaptable to a range of plastic-rich materials sourced from both post-industrial and post-consumer waste to achieve commercial viability.

Many processes for identifying and separating materials are known in the art. However, not all processes are efficient for recovering plastics and the sequencing of these processes is one factor in developing a cost-effective recovery process. Accordingly, there is always a need for improved methods and systems for recovering plastics from a waste stream.

### SUMMARY

This application discloses methods for processing waste material to separate plastics. The method includes receiving waste material containing plastics, sizing the material by size and shape to recover a sized fraction, and comminuting or shredding the sized fraction. The separated material is subjected to gravity separation at approximately 1.0 specific gravity (SG), producing a light fraction (first lights) and a heavy fraction (first sinks). A second gravity separation, set at approximately 1.15 SG, further separates the first lights into a second light fraction consisting of Acrylonitrile Butadiene Styrene (ABS) and Polystyrene (PS) plastics, while the second sinks consist of other polymers, such as filled polymers, which may undergo further processing.

Another aspect includes a system for separating materials from mixed waste feedstock, featuring a feeder to control the flow of material, a size reduction unit to reduce oversized waste to a desired particle size, and a dewatering or drying unit to reduce moisture content. The system also includes a first sink-float separator set at approximately 1.0 SG, separating low-density plastics from denser materials. Downstream, a size classification unit sorts the material into various size fractions, discarding undersized material. A second sink-float separator set at approximately 1.15 SG separates polypropylene (PP) and polyethylene (PE) from ABS and PS. The system also features a friction-based sorting system to remove rubber and foam contaminants and an output stage to deliver purified fractions for recycling.

Another aspect includes a magnetic separator positioned upstream of the size reduction unit to remove ferrous materials, protecting downstream components.

Another aspect includes operating the first sink-float density separator at approximately 1.0 SG to separate light plastics such as PP and PE from denser materials like metals and composites.

Another aspect includes configuring the second sink-float separator to operate at approximately 1.15 SG, enabling effective separation of mid-density plastics such as ABS and PS from heavier, filled polymers.

Another aspect includes a friction-based sorting system after the second sink-float separator, designed to remove non-recyclable contaminants like rubber and foam from the midweight plastic fraction, enhancing the purity of the final ABS and PS plastic streams for further recycling.

Another aspect includes a method where comminuting the sized fraction is performed using a ball mill to enhance the liberation and separation of plastics.

Another aspect includes a method where the first gravity separation is performed at approximately 1.0 SG.

Another aspect includes a method where the second gravity separation is performed at approximately 1.15 SG.

Another aspect includes a method where comminution is carried out with either a ball mill or a rod mill.

Another aspect includes a method where the sizing step involves sorting the waste material by shape.

Another aspect includes conducting the gravity separation process in two stages—first at 1.0 SG, then at 1.15 SG—for precise and efficient plastic material separation.

Another aspect includes recovering ABS and PS plastics from the second floats obtained in the second gravity separation.

Another aspect includes optimizing the comminution process by adjusting the operational parameters of the ball or rod mill to maximize the liberation and separation of plastics.

Another aspect includes shredding the waste material as an initial step.

Another aspect includes processing waste material derived from automobile shredding.

Another aspect includes pelletizing the extracted plastic material for recycling.

Another aspect includes sorting the second floats by color to refine the recovery process.

Another aspect includes a system for recovering plastics from waste material, comprising an input assembly, a sizing unit to sort material by size and shape, and a comminution device to separate plastics from non-plastics, producing a mixture of both. A first gravity separator operates within the range of 0.95 to 1.05 SG, yielding first floats and first sinks, while a secondary gravity separator, set between 1.1 and 1.2 SG, separates second floats and sinks. The comminution device can be either a ball mill or a rod mill.

Another aspect includes a system that incorporates a shredder for the initial waste material processing.

Another aspect includes a system featuring a color sorter for additional sorting.

Another aspect includes a system that uses a shaker table for sorting second floats.

Another aspect includes a system that incorporates a ferrous magnet for magnetic separation.

Another aspect includes a system that features a dryer for moisture reduction.

Another aspect includes a system that incorporates a clarifier for liquid waste treatment.

### BRIEF DESCRIPTION OF THE FIGURES

FIG. 1 illustrates the multi-stage plastic recycling system.

FIG. 2 illustrates another embodiment of a method designed for processing waste material to separate plastics;

FIGS. 3A and 3B illustrate another embodiment of a method designed for processing waste material to separate plastics; and

FIG. 4 shows another embodiment that is a system for separating and recovering plastics from waste material.

### DETAILED DESCRIPTION

This application details various methods and systems for providing a multi-stage process designed to separate and recover high-quality plastics from mixed feedstock.

In specific instances, the process involves the extraction of unwanted plastics and nonplastic substances from a material consisting predominantly of a single type of plastic. Alternatively, the purification may also entail the removal of undesirable plastics and non-plastic elements from a waste material that comprises a group of two or more types of plastics.

This application encompasses methods and systems for recovering plastics from materials or waste, applicable in both wet and dry processes. Wet processes can include, but are not limited to, streams from pre-concentrators, water table concentrators, gold shaking tables (such as those produced by Diester); Wilfley table concentrators; sink-float tanks and vessels; snail drums and barrel washers; processes utilizing heavy media, such as DMS (Dense Media Separation) separators and hydro-cyclones.

Dry processes may involve roughers like air aspirators or Z-box aspirators (widely used in the EU for pre-concentrating automobile shredder residue). The light fraction in such residue often contains embedded or entangled plastics along with fibrous materials like carpet, foam, fiber, or fabrics. Other dry separation equipment includes dry destoners, friction separators, ballistic separators, air tables, cyclones, blowers, air knife separators, or other dry separation devices that differentiate light from heavy materials, where light fractions typically include fuzz and fibrous materials with embedded plastics. Experts in the field are familiar with other relevant wet and dry processes.

One embodiment begins with the introduction of the mixed feedstock into a feeder, where it is directed into a gravity separation unit that operates at a specific gravity (SG) of 1.0 or 1.15. The gravity separation unit can be water-based, like a hydrocyclone, or air-based, depending on the nature of the material being processed and its moisture content. This separation step divides the materials into two streams: those with an SG greater than 1.0 (heavier materials such as metals or denser plastics) and those with an SG less than 1.0 (lighter materials, including low-density plastics like polyethylene or polypropylene). This initial segregation allows for the efficient downstream processing of each fraction.

The removal of ferrous metal contaminants can be accomplished using a magnetic separator. Depending on the type of feedstock and the required efficiency, this magnetic separator may be a pluck magnet, a drum magnet, or an overbelt magnet. The magnet extracts iron concentrate and other ferrous materials, ensuring that only non-ferrous materials proceed to the subsequent steps. If the material contains non-ferrous metals such as aluminum or copper, an eddy current separator may be added after the magnetic stage to remove these metals, thereby increasing the purity of the non-metallic fractions.

Following magnetic separation, the lighter fraction is conveyed to a shredder. This shredding process reduces the material to a shredded size of approximately 12 mm (0.47 inches), making it easier to handle and process in subsequent steps. A single-shaft or dual-shaft shredder may be used, depending on the volume of material and the specific requirements of the process. In some instances, a granulator may be used instead of a shredder to achieve a more uniform particle size distribution. In some examples, the material can be shredded to sizes of less than 14 mm (0.55 inches), 13 mm (0.51 inches), 12 mm (0.47 inches), 11 mm (0.43 inches), 10 mm (0.39 inches), or 9 mm (0.35 inches).

The shredded material is then passed through a double-screen system, which separates the material into three size fractions. Material larger than 12 mm (0.47 inches) is returned to the shredder for further size reduction, while material between 1 mm (0.039 inches) and 12 mm (0.47 inches) is transferred to a dewatering or heated screw. Material smaller than 1 mm (0.039 inches) is discarded as waste. The screening system may use vibrating or rotary drum screens, depending on the desired throughput and separation efficiency. In some configurations, multiple screens with varying mesh sizes may be used to achieve finer granulation of the material.

The mid-sized fraction is sent to a dewatering screw, which removes moisture from the material. In some cases, a heated screw is used to soften certain types of plastics, making them easier to separate in subsequent steps. Depending on the process configuration, alternative drying methods, such as infrared drying or air drying, may be used in place of the dewatering screw.

After drying, the material can be fed into a vacuum pressure separator (VPS). This equipment uses vacuum and pressure differentials to separate the material into three streams: heavies, mids, and lights. The heavy fraction, which contains dense materials such as metals or high-SG plastics, is collected separately for disposal or further processing. The mid-fraction, which consists primarily of high-grade plastics, continues to the next stage, while the light fraction, composed of low-density materials like foams and fibers, is sent to a cyclone separator for further refinement. In an alternative configuration, wet or dry tabling systems can be used to separate the materials based on density if vacuum pressure separation is not available or suitable for the specific feedstock characteristics.

In the cyclone separator, the light fraction is subjected to centrifugal forces that separate fine contaminants, such as fuzz and fiber, from the plastic materials. The cyclone separator can be configured as a single-stage or multi-stage unit, depending on the level of contamination in the feedstock and the desired degree of purification. Alternatively, air classifiers or centrifugal sifters can be employed in this step, providing additional flexibility in the handling of light materials, particularly in processes where a high level of fiber contamination is present.

After cyclone purification, the mid-fraction, which contains the high-grade plastics, moves on to a cascaded friction sorter. The friction sorter uses a mechanical process to clean the plastics by applying friction between the particles and the sorting surfaces. This friction effectively removes any remaining rubber, adhesives, or other contaminants from the plastics. The cascaded design allows the material to pass through multiple friction sorting stages, ensuring a high level of purity in the final product. In an alternative embodiment, an air knife system can be used in place of the friction sorter. The air knife system blows lighter contaminants away from the denser plastics using controlled air streams. For certain materials, triboelectric or optical sorting systems can be added to enhance the separation of plastics based on their surface properties or optical characteristics.

Once the friction sorting process is complete, the final step involves the separation of any remaining rubber or low-quality materials from the high-grade plastics. The rubber and other contaminants are discarded, leaving behind a clean, concentrated stream of high-grade plastics that are suitable for further processing. Depending on the desired end use, the high-grade plastics can be pelletized, extruded, or prepared for other forms of recycling or re-manufacturing. In some embodiments of the process, the final plastic concentrate may undergo additional refinement steps, such as washing or chemical treatment, to further enhance its purity. For example, a wash line may be integrated to remove any surface residues or oils, which is especially useful for plastics that have been used in food packaging or automotive applications. Chemical treatments, such as caustic washing or solvent extraction, can also be used to remove specific types of contaminants, such as inks, adhesives, or other surface treatments that may still be present in the plastic concentrate.

The process is highly adaptable and can be tailored to suit a wide range of input feedstocks, including municipal plastic waste, automotive shredder residue, and industrial plastic scrap. Various alternative components and configurations can be utilized depending on the specific characteristics of the feedstock and the desired purity of the final product. For example, if the input material contains a significant amount of non-ferrous metals, an eddy current separator can be added after the magnetic separation stage to remove these metals and increase the purity of the plastic fractions. Additionally, for feedstocks containing a large amount of moisture or oily residues, advanced drying techniques such as infrared drying or superheated steam drying can be used to ensure the material is properly prepared for separation.

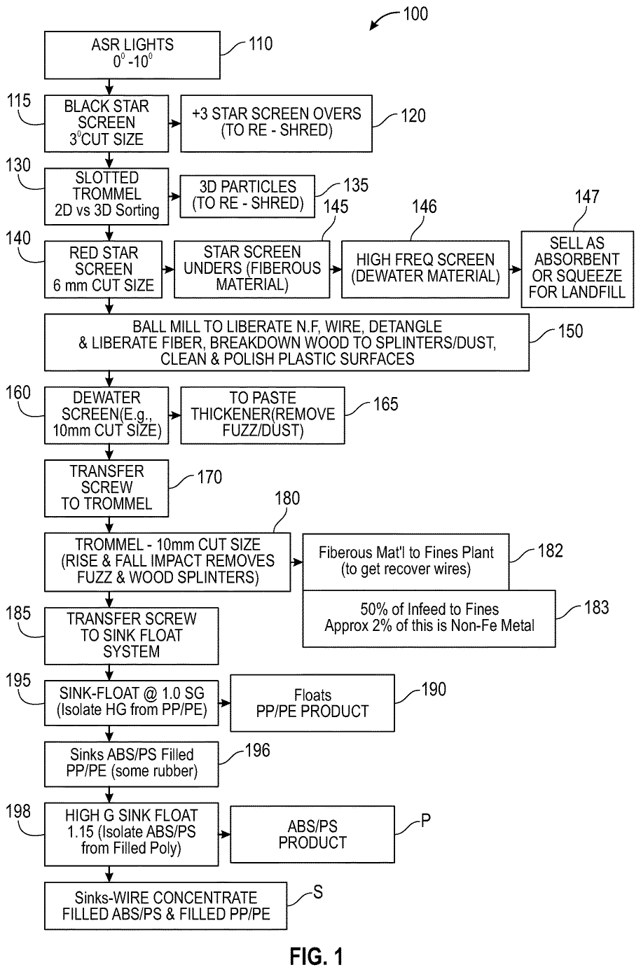

FIG. 1 illustrates an embodiment of a method for separating and recovering plastics from a mixed feedstock comprising the steps of: feeding the material into a gravity separator set at a specific gravity (SG) of 1.0; separating the material into heavy and light fractions based on specific gravity; removing ferrous contaminants using a magnetic separator; shredding the light fraction to a particle size of approximately 12 mm (0.47 inches); screening the shredded material into at least three size fractions; discarding material smaller than 1 mm (0.04 inches) as waste; dewatering the mid-sized fraction; using vacuum pressure separation to further separate the material into heavies, mids, and lights; purifying the light fraction via cyclone separation; cleaning the mid-fraction through friction sorting to remove rubber and contaminants; and recovering high-grade plastics.

As shown in FIG. 1, a mixed feedstock comprising plastics, metals, and contaminants is introduced into a feeder (110). The material can be screened (115) using a star screen, which cuts the material at, for example, 3 inches (76 mm). The undersized material can be directed to a trommel or slotted trommel (130) for size separation, such as ⅛ inch to ½ inch (3.2 mm to 12.7 mm), and larger pieces can be shredded or further size reduced. Another screening step (e.g., ⅛ inch to ½ inch) can be used to remove fibrous material (145), which can be dewatered (146) using a high-frequency screen and placed in a landfill (147). The material under the screen size can be sent to a ball mill (150), which can liberate file, break wood, and further polish the material. The material can be dewatered using a screen (165) at about 10 mm (0.39 inches) to remove, for example, dust and fuzz. The material can be transferred to a trommel to screen at about 10 mm (180) to remove wood using, for example, a transfer screw (185). Fibrous material can be further processed (182) to remove materials, such as wire, and for recovering non-ferrous metals (183). The material is directed to a gravity separation unit (195), which is calibrated to a specific gravity of 1.0. In this step, materials with an SG greater than 1.0 (heavy fraction) sink, while materials with an SG less than 1.0 (light fraction) float. The separation allows for effective downstream processing by segregating denser materials such as metals from less dense plastics. The float can be polypropylene (PP) and polyethylene (PE) (190). The heavies or sink (196) can be processed using density separation at a specific gravity of approximately 1.15 (198), using the same separation methods described. Additionally, it includes an electrostatic sortation machine at the end of the line to further differentiate between various high-grade plastics such as acrylonitrile butadiene styrene (ABS), polystyrene (PS), and filled PP/PE.

In one embodiment, following gravity separation, the heavy fractions pass through a magnetic separator (130) to remove ferrous metal contaminants. The magnetic separator can be a pluck magnet or drum magnet, ensuring the removal of iron concentrate and other ferrous metals.

The light fraction (SG<1.0) is conveyed to a shredder (140), which reduces the particle size of the material to approximately 12 mm (0.47 inches). This shredding process facilitates further screening and size-based separation.

In one embodiment, the shredded material is screened using a double-screen system. The screening separates the material into three categories: Material greater than 12 mm (0.47 inches) is returned to the shredder for additional size reduction; material between 1 mm (0.04 inches) and 12 mm (0.47 inches) is conveyed to the dewatering screw for further processing; and material less than 1 mm (0.04 inches) is discarded as waste.

In one embodiment, the mid-sized fraction is sent to a dewatering screw to remove moisture. Alternatively, a heated screw may be used to reduce the material's moisture content, preparing it for separation by density.

In one embodiment, the dried material is passed through a vacuum pressure separator (VPS), which separates the material into heavies, mids, and lights based on density differences. The vacuum separator is a critical component that enables efficient separation of high-grade plastics (mid-fraction) from heavier and lighter contaminants.

In one embodiment, the light fraction from the VPS is directed to a cyclone separator, where fuzz, fiber, and fine contaminants are removed from the low-density materials. This purification step enhances the quality of the light fraction.

In one embodiment, the mid-fraction is processed through a cascaded friction sorter, which uses mechanical friction to remove rubber and other contaminants from the high-grade plastics. This ensures a high purity of the final plastic product.

In one embodiment, the cleaned, high-grade plastics are separated from any remaining rubber or contaminants. The result is a concentrated stream of high-grade plastics, ready for further recycling or commercial use.

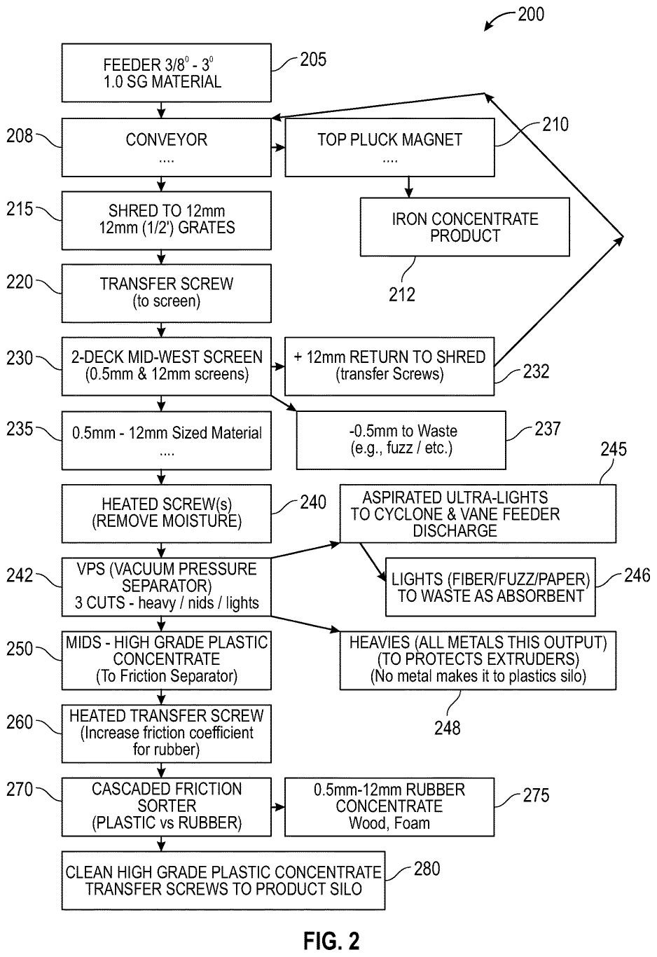

As shown in FIG. 2, a mixed feedstock comprising plastics, metals, and contaminants is introduced into a feeder (205). An iron concentrate (212) may be removed using a magnet (210) along a conveyor (208). The shredded material (215) can be screened using a double-screen system (230) and transferred to the screen (230) using a transfer screw (220). In one example, the screening separates the material into three categories: Material greater than 12 mm (0.47 inches) is returned to the shredder for additional size reduction (232); material between 1 mm (0.04 inches) and 12 mm (0.47 inches) is conveyed to the dewatering screw for further processing (235); and material less than 1 mm (0.04 inches) is discarded as waste (237). The mid-sized fraction (235) is sent to a dewatering screw to remove moisture. Alternatively, a heated screw may be used to reduce the material's moisture content (240), preparing it for separation by density. The dried material is passed through a vacuum pressure separator (242), which separates the material into heavies (248), mids (242), and lights (245) based on density differences. The vacuum separator is a component that enables efficient separation of high-grade plastics (mid-fraction) from heavier and lighter contaminants. The light fraction from the VPS is directed to a cyclone separator (245), where fuzz, fiber, and fine contaminants (248) are removed from the low-density materials. This purification step enhances the quality of the light fraction. The mid-fraction is processed through a cascaded friction sorter (260) using a heated transfer screw (260), which uses mechanical friction to remove rubber and other contaminants from the high-grade plastics. This ensures a high purity of the final plastic product, which can be further processed to separate plastics. The material is directed to a gravity separation unit, which is calibrated to a specific gravity of 1.0. In this step, materials with an SG greater than 1.0 (heavy fraction) sink, while materials with an SG less than 1.0 (light fraction) float. The separation allows for effective downstream processing by segregating denser materials such as metals from less dense plastics. The float can be PP and PE. The heavies or sink can be processed using density separation at a specific gravity of approximately 1.15, using the same separation methods described. Additionally, it includes an electrostatic sortation machine at the end of the line to further differentiate between various high-grade plastics such as ABS, PS, and filled PP/PE.

In one embodiment, the cleaned, high-grade plastics are separated from any remaining rubber or contaminants. The result is a concentrated stream of high-grade plastics, ready for further recycling or commercial use.

In one embodiment, a screening step (e.g., at ⅛ inch to ½ inch) can be used to remove fibrous material, which can be dewatered (146) using a high-frequency screen and placed in a landfill (147). The material under the screen size can be sent to a ball mill (150), which can liberate file, break wood, and further polish the material. The material can be dewatered using a screen (165) at about 10 mm (0.39 inches) to remove, for example, dust and fuzz. The material can be transferred to a trommel to screen at about 10 mm (180) to remove wood using, for example, a transfer screw (185). Fibrous material can be further processed (182) to remove materials, such as wire, and recover non-ferrous metals (183).

FIG. 2 illustrates another embodiment for further recycling and processing of plastics with a specific gravity of around 1.0. This system follows a similar multi-stage process and includes size reduction, iron removal, drying, and separation to ensure high-quality plastic recovery. This embodiment promotes sustainable plastic recycling practices by reducing waste and contributing to a more circular, eco-friendly economy. In this embodiment, the system employs particle size reduction at the outset. Incoming plastic materials, which may be as large as 3 inches (76 mm), are processed through shredders or chippers to reduce their size. Oversized particles are returned to the beginning of the process for further shredding to ensure uniform particle size, which is essential for optimal separation in subsequent stages.

The system also incorporates iron removal using a top pluck magnet. This magnet is integrated to remove any incidental iron contaminants from the plastic materials, safeguarding downstream equipment and enhancing product quality.

A heated screw conveyor can be used for surface drying the plastic particles after shredding. The screw conveyor can be equipped with heated flights or casings to effectively dry the plastics without the need for excessive external heating. Since plastics do not absorb moisture, this process removes surface moisture and prepares the materials for efficient separation.

The system can use a vacuum pressure separator (VPS) to separate materials into three distinct cuts: super light particles, which may contain fuzz and fibers; mid-range plastics, which are generally clean and appropriately sized; and heavies, such as metals or high-density plastics. The super light particles can be processed further, with fuzz being retained for applications such as absorbent cover materials or lightweight landfill products. The mid-range plastics are typically of high enough quality to be stored for reuse or further processing, while the heavies are collected for post-processing to recover any valuable materials.

The light fraction from the VPS is sent to a cyclone separator to remove any remaining fuzz and fibers, purifying the plastics further. After this step, the mid-range plastics are passed through a cascaded friction sorter, where friction is used to separate any remaining rubber from the high-grade plastics. This ensures that the plastic concentrate is of high purity. For added assurance, a second in-line friction separator can be included to guarantee that the final product is free from rubber contamination.

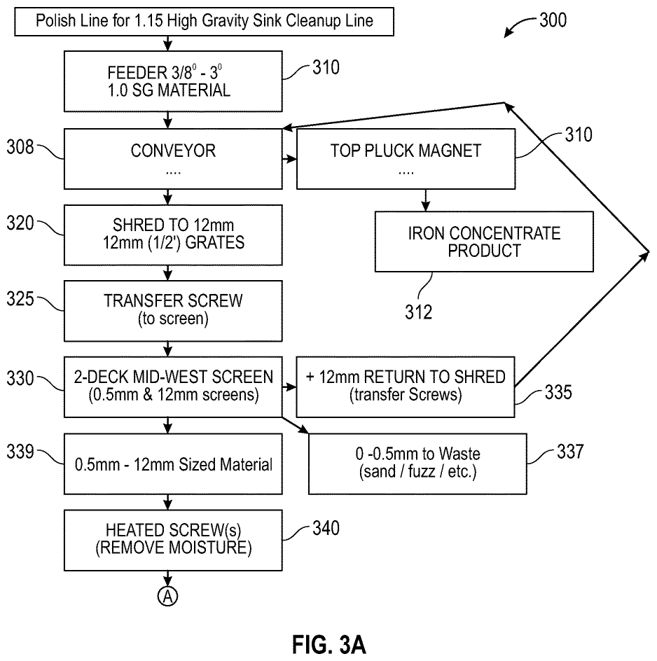

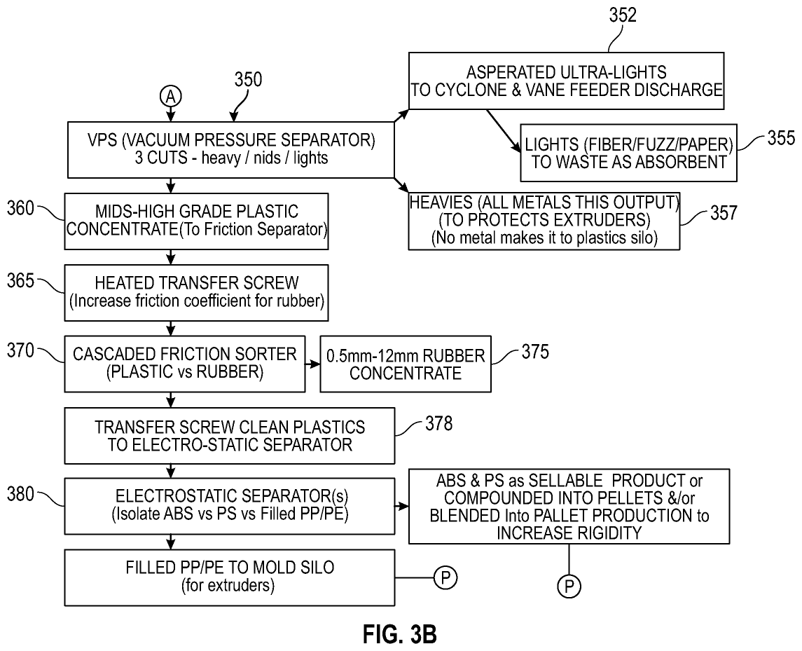

FIG. 3A and FIG. 3B show an extension of the embodiment described in FIG. 2. This system can process plastics with a specific gravity of approximately 1.15, using the same separation methods described. Similar to the method shown in FIG. 2, a mixed feedstock comprising plastics, metals, and contaminants is introduced into a feeder (310). An iron concentrate (312) may be removed using a magnet (310) along a conveyor (308). The shredded material (320) can be screened using a double-screen system (330) and transferred to the screen (339) using a transfer screw (325). In one example, the screening separates the material into three categories: Material greater than 12 mm (0.47 inches) is returned to the shredder for additional size reduction (335); material between 1 mm and 12 mm (0.04 to 0.47 inches) is conveyed to the dewatering screw for further processing (339); and material less than 1 mm (0.04 inches) is discarded as waste (237). The process continues at reference (A).

The material at reference (A) can be processed using a vacuum separator (350) to separate high-grade plastics (mid-fraction or less than about 1.2 specific gravity) from heavier and lighter contaminants using specific gravity. The light fraction from the VPS is directed to a cyclone separator (352), where fuzz, fiber, and fine contaminants (355) are removed from the low-density materials (vacuumed off). This purification step enhances the quality of the light fraction. The mid-fraction is processed through a cascaded friction sorter (370) using a heated transfer screw (365), which uses mechanical friction to remove rubber and other contaminants from the highgrade plastics. The plastics are then sorted using electrostatic separators (380) to separate and isolate AB S vs PS vs filled PS/PE. Additionally, it includes an electrostatic sortation machine at the end of the line to further differentiate between various high-grade plastics such as ABS, PS, and filled PP/PE. The integration of electrostatic sorting ensures that the final recycled materials are of the highest purity.

As seen in FIGS. 1 and 2, density separators are used in the embodiments. Density separators in recycling are specialized equipment used to separate materials based on their density. Density separation, often referred to as “float-sink” separation, involves separating materials based on their density. In density separation, “floats” refer to materials that rise to the surface of the separation medium due to their lower density relative to that medium, while “sinks” refer to materials that settle to the bottom because their density is higher. Density separation exploits the differences in material density for separation. Examples of density separators include, but are not limited to, air separators, hydrocyclones, sink-float tanks, and jigs (e.g., a 3DS shown in U.S. Pat. No. 1,1198,134).

In one embodiment, one density separation is set between 0.9 and 1.1 SG, or 0.95 and 1.05 SG, or at 1.0 SG. Given that plastics have a wide range of densities, density separation is a practical and efficient method for sorting them. The material can be separated using gravity separation. In certain embodiments, the lighter material or “lights” has a specific gravity between 1.0 and 1.4, 1.1 and 1.5, 1.2 and 1.4, or 1.3 and 1.4. In this step, the “sinks” undergo further processing, while the “lights” are processed at a specific gravity of 1.0.

In this embodiment, the waste material can be screened. Screens are used primarily for sorting and separating different types of materials based on size. They effectively segregate larger pieces of plastic from smaller ones and can also remove non-plastic materials mixed with plastic waste. Examples of screens include trommel screens, vibratory screens, and disc screens. These screens may help remove contaminants and non-plastic materials from the plastic waste stream.

In another embodiment, the waste material can be treated with magnetic separators to remove iron. Magnetic separators are used extensively in recycling facilities and scrap yards to recover ferrous metals from various waste streams, including automobile shredder residue, electronic waste, and mixed metal scrap. Magnetic separators utilize the magnetic properties of certain metals for separation. Ferromagnetic materials like iron and steel are attracted to a magnet, while non-ferromagnetic materials are not. Examples of magnetic separators include, but are not limited to, overband magnets, drum magnets, pulley magnets, and the like. The size and type of the magnetic separator and the speed at which materials pass through the separator all influence the effectiveness of separation.

Vacuum pressure separators effectively separate materials based on density and aerodynamic properties, but alternatives exist. Air classification systems use air currents to separate by size, shape, and density, while zig-zag air classifiers enhance separation through turbulent flow. Density separators like fluidized bed separators and jigs utilize a fluid medium and vibrations. Optical sorting employs sensors and cameras to identify materials based on visual characteristics, and electrostatic separation differentiates based on electrical conductivity. The best alternative depends on factors like material properties, desired separation efficiency, throughput, budget, and environmental concerns.

In another embodiment, the less dense or float material from the gravity separation or processed material can be Acrylonitrile Butadiene Styrene (ABS). ABS is a tough, durable plastic used in a wide variety of manufacturing applications. The material is popular for several reasons and has become a standard for many industries. It also helps homogenize the material stream, making it more uniform and easier to work with. Examples of size reducers include, but are not limited to, shredding (cutting), grinding (pulverizing), crushing (pressure), and granulating (chopping). Such equipment can include shredders, hammermills, grinders, and compactors.

In another embodiment, the material can be size-reduced. Size reduction in recycling refers to breaking down materials into smaller pieces, typically to facilitate further processing, handling, and recycling. Size reduction makes materials easier to handle and process.

Size reduction typically includes one or more processes at the front end of a plastics recycling plant that are arranged to accomplish a variety of tasks. Size reduction can be implemented to remove metals that can damage size reduction equipment or negatively affect downstream separation processes, to reduce the plastic particle size such that much of the nonplastic material is liberated, to create a relatively narrow particle size distribution, and possibly to stabilize the composition of materials sent to downstream processes.

In another embodiment, the material can be treated with a color sorter. A color sorter in recycling is a sophisticated machine used to separate items based on their color, an essential function in the recycling of materials like plastics. Color sorters use optical sensors to detect the color of materials as they pass through the machine.

Gravity concentration can be used for various purposes in addition to segregating different types of plastics. For example, gravity concentration can be used to separate different grades of the same plastic type.

In another embodiment, a method is designed for processing waste material to separate plastics. This method for recovering plastics from waste material includes: receiving waste material comprising plastic, which may include automobile shredder residue; sizing the waste material by size and shape to recover a sized fraction, using equipment such as a disc shredder; comminuting the sized fraction (alternatively with a ball or rod mill) to liberate and separate the plastics from the sized fraction, thereby obtaining a mix of plastics and non-plastics; dewatering and using a defusing screen to remove water; removing iron and collecting it using equipment like a dry magnet or high-gauss magnet; separating material using a first gravity separation at about 1.0 SG into first floats and first sinks. The first sinks can include materials like ABS, PS, and styrenes, while the first floats can be composed of polypropylene and polyethylene (PE). The first sinks can undergo a second gravity separation at between 1.1 and 1.2 SG (e.g., 1.15 SG), resulting in second floats and second sinks. The second sinks can include filled polymers (such as glass-filled polymers, talc-filled polymers, or other fiber-reinforced polymers), metals, and copper wire, among other materials. The second floats can consist of Acrylonitrile Butadiene Styrene (ABS) and Polystyrene (PS) plastics. These second floats can be further sorted into lights and darks using a color sorter. The second sinks can either be further processed using other techniques or disposed of properly.

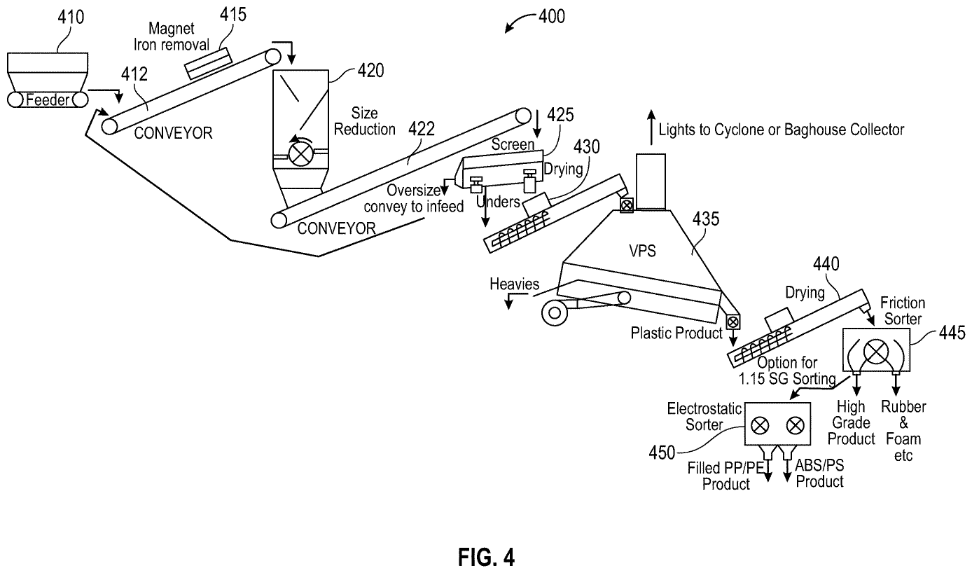

FIG. 4 illustrates an exemplary embodiment of a system (400) designed for the efficient removal of plastics from a stream of waste material, such as automotive shredder residue (ASR). The waste material is initially introduced into a feeder (410), which controls the flow of material into the system. As the material passes through the feeder, an integrated magnetic separator (415) removes any ferrous metals, such as iron, ensuring these contaminants are excluded from subsequent processing stages. The remaining waste can be processed through a shredder (420) or other size reducer, which sizes the material to a specified particle size—typically 6 mm (0.24 inches) or 10 mm (0.39 inches), depending on the desired application. The shredder (420) can reduce oversized particles to a more uniform size, ensuring efficient downstream processing. Any undersized material bypasses this stage and proceeds to a dewatering dryer (430), which reduces moisture content to optimize separation efficiency.

FIG. 3A and FIG. 3B show an extension of the embodiment described in FIG. 2. This system can process plastics with a specific gravity of approximately 1.15, using the same separation methods described. Similar to the method shown in FIG. 2, a mixed feedstock comprising plastics, metals, and contaminants is introduced into a feeder (310). An iron concentrate (312) may be removed using a magnet (310) along a conveyor (308). The shredded material (320) can be screened using a double-screen system (330) and transferred to the screen (339) using a transfer screw (325). In one example, the screening separates the material into three categories: Material greater than 12 mm (0.47 inches) is returned to the shredder for additional size reduction (335); material between 1 mm and 12 mm (0.04 to 0.47 inches) is conveyed to the dewatering screw for further processing (339); and material less than 1 mm (0.04 inches) is discarded as waste (237). The process continues at reference (A).

The material at reference (A) can be processed using a vacuum separator (350) to separate high-grade plastics (mid-fraction or less than about 1.2 specific gravity) from heavier and lighter contaminants using specific gravity. The light fraction from the VPS is directed to a cyclone separator (352), where fuzz, fiber, and fine contaminants (355) are removed from the low-density materials (vacuumed off). This purification step enhances the quality of the light fraction. The mid-fraction is processed through a cascaded friction sorter (370) using a heated transfer screw (365), which uses mechanical friction to remove rubber and other contaminants from the highgrade plastics. The plastics are then sorted using electrostatic separators (380) to separate and isolate AB S vs PS vs filled PS/PE. Additionally, it includes an electrostatic sortation machine at the end of the line to further differentiate between various high-grade plastics such as ABS, PS, and filled PP/PE. The integration of electrostatic sorting ensures that the final recycled materials are of the highest purity.

As seen in FIGS. 1 and 2, density separators are used in the embodiments. Density separators in recycling are specialized equipment used to separate materials based on their density. Density separation, often referred to as “float-sink” separation, involves separating materials based on their density. In density separation, “floats” refer to materials that rise to the surface of the separation medium due to their lower density relative to that medium, while “sinks” refer to materials that settle to the bottom because their density is higher. Density separation exploits the differences in material density for separation. Examples of density separators include, but are not limited to, air separators, hydrocyclones, sink-float tanks, and jigs (e.g., a 3DS shown in U.S. Pat. No. 1,1198,134).

In one embodiment, one density separation is set between 0.9 and 1.1 SG, or 0.95 and 1.05 SG, or at 1.0 SG. Given that plastics have a wide range of densities, density separation is a practical and efficient method for sorting them. The material can be separated using gravity separation. In certain embodiments, the lighter material or “lights” has a specific gravity between 1.0 and 1.4, 1.1 and 1.5, 1.2 and 1.4, or 1.3 and 1.4. In this step, the “sinks” undergo further processing, while the “lights” are processed at a specific gravity of 1.0.

The separation steps at specific gravities (SG) of 1.0 and 1.15 can be performed in either order depending on the nature of the feedstock and the desired outcome. The system is flexible enough to allow for initial separation at SG 1.0, which effectively segregates lighter plastics such as polypropylene (PP) and polyethylene (PE) from denser materials. Subsequently, a second separation at SG 1.15 can refine the process by isolating higher-density plastics, such as ABS and PS, from materials that may still be present in the heavier fraction. Alternatively, the process can begin with separation at SG 1.15 to remove the densest materials like metals and filled plastics, followed by the 1.0 SG separation to distinguish lighter, high-quality plastics from any remaining contaminants. This flexibility in the order of separation allows the system to adapt to various feedstock compositions, ensuring efficient recovery of different plastic types.

In this embodiment, the waste material can be screened. Screens are used primarily for sorting and separating different types of materials based on size. They effectively segregate larger pieces of plastic from smaller ones and can also remove non-plastic materials mixed with plastic waste. Examples of screens include trommel screens, vibratory screens, and disc screens. These screens may help remove contaminants and non-plastic materials from the plastic waste stream.

In another embodiment, the waste material can be treated with magnetic separators to remove iron. Magnetic separators are used extensively in recycling facilities and scrap yards to recover ferrous metals from various waste streams, including automobile shredder residue, electronic waste, and mixed metal scrap. Magnetic separators utilize the magnetic properties of certain metals for separation. Ferromagnetic materials like iron and steel are attracted to a magnet, while non-ferromagnetic materials are not. Examples of magnetic separators include, but are not limited to, overband magnets, drum magnets, pulley magnets, and the like. The size and type of the magnetic separator and the speed at which materials pass through the separator all influence the effectiveness of separation.

Vacuum pressure separators effectively separate materials based on density and aerodynamic properties, but alternatives exist. Air classification systems use air currents to separate by size, shape, and density, while zig-zag air classifiers enhance separation through turbulent flow. Density separators like fluidized bed separators and jigs utilize a fluid medium and vibrations. Optical sorting employs sensors and cameras to identify materials based on visual characteristics, and electrostatic separation differentiates based on electrical conductivity. The best alternative depends on factors like material properties, desired separation efficiency, throughput, budget, and environmental concerns.

In another embodiment, the less dense or float material from the gravity separation or processed material can be Acrylonitrile Butadiene Styrene (ABS). ABS is a tough, durable plastic used in a wide variety of manufacturing applications. The material is popular for several reasons and has become a standard for many industries. It also helps homogenize the material stream, making it more uniform and easier to work with. Examples of size reducers include, but are not limited to, shredding (cutting), grinding (pulverizing), crushing (pressure), and granulating (chopping). Such equipment can include shredders, hammermills, grinders, and compactors.

In another embodiment, the material can be size-reduced. Size reduction in recycling refers to breaking down materials into smaller pieces, typically to facilitate further processing, handling, and recycling. Size reduction makes materials easier to handle and process.

Size reduction typically includes one or more processes at the front end of a plastics recycling plant that are arranged to accomplish a variety of tasks. Size reduction can be implemented to remove metals that can damage size reduction equipment or negatively affect downstream separation processes, to reduce the plastic particle size such that much of the nonplastic material is liberated, to create a relatively narrow particle size distribution, and possibly to stabilize the composition of materials sent to downstream processes.

In another embodiment, the material can be treated with a color sorter. A color sorter in recycling is a sophisticated machine used to separate items based on their color, an essential function in the recycling of materials like plastics. Color sorters use optical sensors to detect the color of materials as they pass through the machine.

Gravity concentration can be used for various purposes in addition to segregating different types of plastics. For example, gravity concentration can be used to separate different grades of the same plastic type.

In another embodiment, a method is designed for processing waste material to separate plastics. This method for recovering plastics from waste material includes: receiving waste material comprising plastic, which may include automobile shredder residue; sizing the waste material by size and shape to recover a sized fraction, using equipment such as a disc shredder; comminuting the sized fraction (alternatively with a ball or rod mill) to liberate and separate the plastics from the sized fraction, thereby obtaining a mix of plastics and non-plastics; dewatering and using a defusing screen to remove water; removing iron and collecting it using equipment like a dry magnet or high-gauss magnet; separating material using a first gravity separation at about 1.0 SG into first floats and first sinks. The first sinks can include materials like ABS, PS, and styrenes, while the first floats can be composed of polypropylene and polyethylene (PE). The first sinks can undergo a second gravity separation at between 1.1 and 1.2 SG (e.g., 1.15 SG), resulting in second floats and second sinks. The second sinks can include filled polymers (such as glass-filled polymers, talc-filled polymers, or other fiber-reinforced polymers), metals, and copper wire, among other materials. The second floats can consist of Acrylonitrile Butadiene Styrene (ABS) and Polystyrene (PS) plastics. These second floats can be further sorted into lights and darks using a color sorter. The second sinks can either be further processed using other techniques or disposed of properly.

FIG. 4 illustrates an exemplary embodiment of a system (400) designed for the efficient removal of plastics from a stream of waste material, such as automotive shredder residue (ASR). The waste material is initially introduced into a feeder (410), which controls the flow of material into the system. As the material passes through the feeder, an integrated magnetic separator (415) removes any ferrous metals, such as iron, ensuring these contaminants are excluded from subsequent processing stages. The remaining waste can be processed through a shredder (420) or other size reducer, which sizes the material to a specified particle size—typically 6 mm (0.24 inches) or 10 mm (0.39 inches), depending on the desired application. The shredder (420) can reduce oversized particles to a more uniform size, ensuring efficient downstream processing. Any undersized material bypasses this stage and proceeds to a dewatering dryer (430), which reduces moisture content to optimize separation efficiency.

The material or the dewatered material can be conveyed into a vacuum pressure separator (435). This advanced separator classifies the material into three fractions based on their specific gravities: heavy, mid-weight, and light fractions. The heavy fraction often consists of denser materials, such as metals or highly filled plastics, while the light fraction typically contains foams, films, or other low-density materials. The mid-weight fraction may include materials such as partially filled plastics or composites. The mid-weight fraction is further processed through a secondary dryer (440), which removes any residual moisture to prepare the material for subsequent sorting. This step ensures optimal conditions for the separation of plastics and other components.

The material can be directed into a friction sorter (445), which separates rubber, non-recyclable waste, and plastic products based on differences in surface properties and frictional behavior. The friction sorter (445) is particularly effective in removing contaminants like rubber and textiles, which have different surface textures compared to plastics.

The plastic product can be processed through a density separator (450). This step helps achieve precise separation of different plastic types. The density separator (450) operates at a specific gravity cut point, typically around 1.15 SG, to divide the plastics into two main categories: (1) a concentrated stream of filled polypropylene (PP) and polyethylene (PE), and (2) a separate stream containing Acrylonitrile Butadiene Styrene (ABS) and Polystyrene (PS) concentrates. The density separator (450) uses differences in buoyancy to achieve this separation, ensuring a high purity of recycled plastic streams. The output of the system includes clean, separated plastic fractions that are ready for further refinement or direct recycling into new products, contributing to the circular economy and reducing landfill waste.

The waste material can be crushed and reduced using a comminution device. In the context of recycling and waste management, particularly for the recovery of plastics from waste material, a comminution device can reduce the size of various materials. The comminution device can also separate fuzz materials, scrub the surface of plastics, and separate wood from the material. Common types of comminution devices include ball mills and rod mills. During operation, the drum of the mill rotates, causing the grinding media and the material to be lifted and then dropped or rolled, creating an impact and grinding action. This action progressively reduces the size of the material. Comminution devices often allow for adjustments in operation parameters like the speed of rotation, the size and type of grinding media, and the duration of the grinding process, optimizing the comminution for different types of materials. The output from a comminution device typically consists of a mixture of reduced-size particles. In plastic recovery, this output will usually be a mixture of plastics and non-plastics, which can then be further processed and separated.

Specific gravity separation is a method used to separate particles based on their specific gravity (SG), which is essentially a ratio of the density of a substance to the density of a reference substance, typically water. Specific gravity separation exploits the differences in the specific gravity of particles in a mixture. Since specific gravity is directly related to density, this method effectively separates materials with different densities. When the mixture is immersed, particles will start to separate based on their densities relative to the medium. Denser particles settle at the bottom, while lighter particles rise to the top. In recycling, this method is used to separate materials like metals and plastics based on their density.

The initial step involves introducing light materials or concentrates with fibrous content, typically obtained from coarse or preliminary processing. The materials then undergo comminution using a milling device, such as a ball mill, tumbling mill, drum mill, or rod mill. This process effectively separates wood, fibers, or fuzz entangled in or attached to the plastics. Subsequently, the comminuted material is sorted by size. In one approach, this sorting or screening is followed by additional processing to recover materials. Alternatively, the feedstock or crushed material may undergo magnetic treatment (e.g., with magnetite) and is then screened accordingly. An optional step includes sorting for flatter plastics of sizes less than 4 inches (100 mm), 3 inches (75 mm), 2 inches (50 mm), or 1 inch (25 mm). This size separation can be performed using equipment like a trommel.

The initial waste streams contain amounts of rubber, wood, metal, wires, circuit boards, foam, glass, and other non-plastics. Size reduction methods and systems configured to perform these processes have been developed such that feed streams rich in plastics can be separated into multiple products and byproduct streams. The methods and systems can be applied to a variety of plastics-rich streams derived from post-industrial and post-consumer sources. These streams can include plastics from office automation equipment (e.g., printers, computers, copiers), white goods (e.g., refrigerators, washing machines), consumer electronics (e.g., televisions, video cassette recorders, stereos), automotive shredder residue, packaging waste, household waste, building waste, and industrial molding and extrusion scrap. This material can be processed by specific embodiments of this invention.

This application discloses systems for various sorting of waste material (e.g., automobile shredder residue, municipal waste, or similar). This application includes methods and systems for recovering plastics through the use of comminution (e.g., a ball mill or rod mill). Specific embodiments may be carried out in wet or dry processes on waste material (e.g., automobile shredder residue). Wet processes can include a slurry or dry mix of fibrous feedstock (e.g., containing fibrous organic material, plastic material, and plastics). Specific embodiments include processing of fibrous feedstock that is aspirated lights (light material from an aspirator) and/or lights from a wet rougher or process, such as a heavy media plant or rising current separation using water.

In one embodiment, the processes and systems were found to be highly effective in recovering plastics from aspirated waste, common in the European Union from processes that do not involve incineration. Aspirators, well-known in the classifying art, result in a light fraction having organic material with limited amounts of metal, which tends to be buried, embedded, or entangled with organic fibers. Often, the fibrous feedstock contains buried, embedded, or entangled plastic. This type of waste is referred to here as aspirated fibrous feedstock. One method for recovering plastics from waste includes coarsely separating the plastics from the waste to leave a light concentrate, comminuting the light concentrate with a mill to liberate and separate the fibrous feedstock to obtain a mix of a metal fraction and residue, and collecting the plastics fraction and the residue.

Another embodiment can include a device to remove fuzz. Such devices are known in the art.

In other embodiments, the separation may include an inertia table that consists of a frame, a tray or tilt tray, a cam, and a motor. The tray can be secured to pneumatic cylinders or springtype elements, which in turn are secured to the frame. Materials processed by the upstream delivery station are accumulated on or conveyed by a tray, which separates and moves material by creating a moment of inertia and/or rotary motion, which is translated into a reciprocating or oscillating motion (e.g., a stroke or follower motion). As a result, heavier materials are carried forward, and the lighter materials are carried backward. One exemplary inertia table is available from TAV Holdings, Inc.

Another embodiment includes a method of recovering a plastic product with a given particle size distribution. This method includes loading material with fibrous organic material into a ball mill and operating the ball mill to mill the material, which separates or liberates the organic fibrous material from the plastics. The ball milling liberates and removes the fibrous material, resulting in recovered plastics.

Conveyors are used to move materials throughout the system. In one example, the rejects from the eddy currents can be combined with the “lights” fraction and conveyed to a ball mill.

Aggregates and glass are pulverized into smaller fractions than aluminum, copper, and other metals and can be effectively screened.

The waste material may contain less than 60%, 50%, 40%, 30%, 20%, 10%, 6%, 5%, 4%, 3%, 2%, or 1% of plastics by weight or volume. In some examples, the fibrous light material contains greater than 95% plastics or organics.

Since the amount of recyclable materials recovered may increase, a monetary amount may be associated with this increase, based on the systems or methods discussed in the various embodiments. For example, an additional recovery of $40.00 to $60.00 USD per ton of shredded material may be obtained from salable recyclable materials compared to past techniques. These values may vary depending on the market and the amount of recyclables recovered, but it provides a substantial increase in salable materials.

Sorting of traditional waste material may be run once, repeated, run twice, or repeated twice or more as needed.

With regard to the waste stream, specific embodiments can be used to process waste materials or recyclable materials containing a concentration of plastics larger than 15%, 25%, 35%, 45%, or 50%. This means that as long as there is a good concentration of plastics, as low as 20% or higher, the system can properly sort the materials. Household waste that has been pre-sorted into “plastic and non-plastic” streams is a good example. Typically, household waste that is not landfilled can be pre-sorted at a recycling facility where plastic separation occurs. This plastics concentrate is one example of a “good feed material.” Municipal waste containing plastics is another exemplary waste stream material.

The plastics recycling process may employ various separation techniques, strategically sequenced to maximize efficiency and yield a valuable mix of products. The arrangement of these processes can vary based on the source, particle size, and characteristics of the waste plastic material. In certain implementations, specific operations may be repeated as necessary to attain the desired purity level or if different stages of the process call for the same operation for distinct purposes.

In one embodiment, the intake material or feed material is pre-processed material. Preprocessing the material can include steps such as gravity separation, density separation, sorting, thickness sorting, friction sorting, and other types of processing.

The separated plastics may undergo further processing to remove undesirable materials that remain in the plastic streams. For example, a rollback conveyor, which includes an upwardly inclined conveyor, may be used to remove rounded materials, such as foam, from the plastic stream. As the material moves on the conveyor, the round foam and similar material rolls back down the conveyor because it does not create enough friction to remain on the conveyor as it travels. The material removed with this process is typically waste.

Similarly, the material may be transferred to a magnetic belt. At this stage, ferrous debris is removed. For example, fuzz or fluff, which can consist of carpet fragments from an automobile that may contain ferrous metal threads, would be removed. This ferrous debris would typically be considered waste. Other processes may be employed to remove undesirable plastics, such as talc-filled polypropylene (PP), glass-filled polymers, and polyvinyl chloride (PVC). These processes may be skipped or additional steps added to produce a concentrated plastic stream that can be processed to remove contaminants like PCBs. The plastic may be further reduced in size as necessary. Alternatively, these pre-processing activities could be done prior to concentrating the plastic materials in a sink/float tank.

Additional separations, tanks, and devices may be added to improve efficiency and speed in the system.

In one embodiment, the feed material can be automobile shredder residue (ASR). Automotive Shredder Residue (ASR), typically constituting 15-25% of a vehicle's mass at its end-of-life stage (post being an End of Life Vehicle or ELV), is the residual material remaining after processes such as de-pollution, dismantling, shredding of the vehicle's body, and the extraction of metals. ASR can be segmented into three categories: ‘light fluff,’ ‘heavy fluff,’ and a mineral fraction. Both light and heavy fluff are distinguished by their high concentration of combustible materials, including plastics, rubber, and textiles.

The effectiveness of various plastic separation processes can be enhanced by regulating the surface-to-mass ratios of the plastic materials undergoing separation. For instance, in electrostatic sorting, particle deflection is determined by the charge-to-mass ratio, which is generally considered proportional to the surface-to-mass ratio. Additionally, methods like froth flotation and density differential alteration also rely on the surface-to-mass ratio of plastics.

A number of methods can be used to control the surface-to-mass distribution. Sorting by thickness using equipment such as slot sorters or roll sorters can create streams with more narrowly defined surface-to-mass distributions. Other techniques, such as air tables and air classifiers, which depend in part on the surface drag of particles in air, can also be used to separate mixtures into streams with more narrow surface-to-mass distributions. Large particles with a small surface-to-mass ratio can be granulated so they achieve a larger surface-to-mass ratio. Particles with excessively high surface-to-mass ratios (fines) can be removed by screening, tabling, or air classifications.

The separated flakes can be extruded using a single or twin screw extruder. A feed system, which can accurately add prescribed amounts of colorants, impact modifiers, antioxidants, and other additives, is typically included with the extrusion system.

In one embodiment, a process for sorting plastics from waste material can include a specific step for removing plastic flakes from the mixture after an extrusion process. This step can be done using flotation separation or screening methods designed for fine separation of plastic flakes. The separated flakes can be pelletized to a consistent size and shape, which makes the materials ready for subsequent commercial use or recycling processes. A further enhancement of this embodiment can involve using color sorting techniques to identify and segregate different types of plastics within the mix, ensuring more refined sorting and increased material purity.

The extruded plastic flakes or pellets can then be processed further by chemical treatment, such as acid or alkaline washing, to eliminate surface contaminants like oils, dyes, or adhesives, which may have originated from the original waste material. After washing, the plastic can be passed through a drying system, such as a heated drum or infrared dryer, to remove excess moisture, leaving behind clean, dry plastic flakes suitable for various downstream applications.

Specific gravity separation is commonly employed in this recycling process, especially for mixed plastics that vary in density. In one embodiment, a mixed plastic waste stream may be introduced into a tank or vessel containing a medium with a specific gravity between 1.0 and 1.15. Plastics with a lower density, such as polypropylene (PP) and polyethylene (PE), will float, while denser plastics like acrylonitrile butadiene styrene (ABS) and polystyrene (PS) will sink. This float-sink separation allows for the efficient recovery of different plastic types.

As noted earlier, magnetic separators can be incorporated to remove ferrous contaminants. Once the lighter plastics have been floated off, an eddy current separator may be used to remove non-ferrous metals such as aluminum and copper, further purifying the plastic stream.

In another embodiment, size reduction may be accomplished after the specific gravity separation. Size reduction techniques can include shredding, granulating, and grinding to reduce the plastic material to a smaller, uniform size, typically around 6-12 mm (0.24-0.47 inches). This makes it easier to process in subsequent steps. The size reduction may also be done in stages to minimize energy consumption and wear on the equipment.

The output from size reduction can be sent through a screening process where materials larger than 12 mm (0.47 inches) are returned for further size reduction. Material between 1 mm (0.04 inches) and 12 mm (0.47 inches) continues to the next step, while material smaller than 1 mm (0.04 inches) is discarded or treated as waste. In this way, the size-based separation of materials facilitates more efficient downstream processing.

Post-screening, the mid-size plastic fraction can be fed into a dewatering screw or other drying device, such as an infrared dryer or air dryer. The purpose of this step is to remove any remaining moisture from the plastic, preparing it for further separation based on its density.

A vacuum pressure separator (VPS) can be used in another embodiment to separate plastics by density. The VPS works by creating a differential pressure environment, forcing the heavier materials, such as metals or filled plastics, into one stream, while the lighter plastic fractions are separated into different streams for further refinement. The use of vacuum pressure enhances the separation efficiency and increases the purity of the separated plastics.

After vacuum separation, the lighter plastic fraction, containing fuzz, fibers, or foams, can be directed to a cyclone separator. The cyclone separator operates by applying centrifugal forces to remove fine contaminants from the plastic. In one embodiment, a multi-stage cyclone separator may be used to achieve a higher degree of purification.

Following cyclone separation, the mid-range plastic fraction (now mostly high-grade plastic) can be processed through a friction sorter, where friction between the sorting surfaces and the plastic material is used to remove residual rubber, adhesives, or other contaminants. In some cases, multiple friction sorting stages are used to ensure maximum cleanliness of the plastic.

After friction sorting, the purified plastics are now ready for further use or sale. The cleaned plastics, including materials like PP, PE, ABS, and PS, can be pelletized, extruded, or prepared for recycling into new products.

In yet another embodiment, a secondary sorting process can be implemented using electrostatic sorting machines, which use static electricity to further differentiate plastics by type. This is particularly useful for separating high-grade plastics such as ABS and PS from lower-quality materials or filled plastics.

A system designed for the efficient removal and recovery of plastics from waste materials such as automotive shredder residue (ASR) can include multiple stages of size reduction, density separation, magnetic separation, drying, and/or chemical treatment. The system is highly adaptable and can handle different types of feedstock, including municipal waste, industrial plastic scrap, and post-consumer plastic waste.

The effectiveness of the system can be further enhanced by optimizing the arrangement of the separation processes based on the characteristics of the input material. For example, wet processes may be used if the waste material contains a high moisture content, while dry processes may be used for more fibrous materials or when water use needs to be minimized.

The overall goal of the system is to maximize the recovery of high-quality plastics while minimizing the amount of waste generated. This system can be integrated into existing waste management or recycling facilities and tailored to meet the specific requirements of different types of waste streams.

In another embodiment, the system may include a secondary recovery line specifically designed for recovering materials such as rubber, metals, and glass from the waste stream, further increasing the value of the recovered materials and contributing to a more circular, eco-friendly economy.

### EXAMPLE

An experimental trial was conducted using automotive shredder residue (ASR) as the feedstock to validate the effectiveness of the multi-stage plastic separation system. The ASR (100%) contained a complex mixture of plastics, rubber, fibers, metals, and other contaminants, with an estimated plastic content of 19-30%. The initial material was processed through a gravity separator with a specific gravity (SG) of 1.0, which separated the heavier materials (e.g., metals and high-density rubber) from the lighter plastics. Approximately 67.1% of the ASR volume was classified as “lights,” primarily composed of plastics such as ABS, PS, and PP, with a smaller proportion of rubber and fibers.

The lighter fraction was passed through the Star Screen, which successfully liberated over 53.4% of the fibers and fine debris. The remaining plastics were then processed through the ball mill for mechanical cleaning, which removed surface oils and grease. The yield of clean, polished plastics after this stage was approximately 28% of the lighter fraction.

Subsequent sink-float separations, conducted at specific gravities of 1.0 and 1.15, further refined the material. The first sink-float stage, operating at 1.0 SG, recovered 15.1% of the total plastic content, while separating heavier contaminants, such as rubber and wire, which accounted for 10% of the initial ASR. The second sink-float stage, set at 1.15 SG, increased the purity of the ABS and PS plastics, with a recovery yield of 12.9% of the original plastic mass.

Following the vacuum pressure separation (VPS), mid-range plastics were processed through a friction separator, which removed an additional 25.36% of rubber contaminants. The final yield of high-grade plastics, including ABS and PS, was 12.9% of the total ASR input. The purity of the recovered plastics was measured at over 95%, making them suitable for high-quality recycling applications.

Although specific embodiments of the disclosure have been described above in detail, the description is merely for purposes of illustration. It is to be understood that the present description illustrates those aspects of the invention relevant to a clear understanding of the invention. Certain aspects of the invention that would be apparent to those of ordinary skill in the art and that, therefore, would not facilitate a better understanding of the invention have not been presented in order to simplify the present description. Although embodiments of the present invention have been described, one of ordinary skill in the art will, upon considering the foregoing description, recognize that many modifications and variations of the invention may be employed. All such variations and modifications of the invention are intended to be covered by the foregoing description.

What is claimed:

1. A method of separating and recovering materials from a mixed feedstock, the method comprising:
introducing the mixed feedstock into a first gravity separation system operated at a selected specific gravity to separate a lighter fraction from a heavier fraction;
removing metal contaminants from the mixed feedstock or from at least one of the lighter fraction and the heavier fraction using a magnetic separation process;
shredding the lighter fraction to reduce particle size;
screening the shredded lighter fraction into a plurality of size fractions and discarding fine material below a selected size threshold;
dewatering a mid-size fraction of the plurality of size fractions;
separating material from the dewatered mid-size fraction into a plurality of streams based on density differences;
purifying at least one of the plurality of streams by a secondary separation process that removes fine contaminants;
mechanically cleaning a selected fraction to remove surface contaminants and unwanted materials; and
recovering a purified material fraction suitable for further processing or recycling.

2. The method of claim 1, wherein the first gravity separation system is operated at a specific gravity between about 0.9 and about 1.15 to separate high-density materials from lower-density plastics.

3. The method of claim 1, wherein the magnetic separation process comprises a drum magnet, an overbelt magnet, or a pluck magnet configured to remove ferrous metal contaminants.

4. The method of claim 1, wherein the lighter fraction is screened into three or more size fractions, and particles smaller than about 1 mm (0.04 inch) are discarded as waste.

5. The method of claim 1, wherein dewatering comprises using a heated screw conveyor or a high-frequency screen to remove excess moisture from the mid-size fraction.

6. The method of claim 1, wherein separating material from the dewatered mid-size fraction into the plurality of streams comprises vacuum-pressure separating the material into heavy, mid-range, and light streams based on density differences.

7. The method of claim 1, wherein the secondary separation process comprises a cyclone separator, a zigzag air classifier, or an air table configured to remove dust, fibers, or fuzz.

8. The method of claim 1, further comprising mechanically cleaning a mid-range plastic fraction with a friction separator or an air knife system to remove rubber, foam, and other surface contaminants.

9. The method of claim 1, further comprising subjecting at least one stream to electrostatic or triboelectric separation to further differentiate acrylonitrile butadiene styrene (ABS), polystyrene (PS), and filled polypropylene or polyethylene materials.

10. The method of claim 1, wherein shredding reduces the particle size of the lighter fraction to less than about 12 mm (0.47 inch).

11. The method of claim 1, further comprising conducting a second gravity separation process at a different specific gravity to refine separation between high-grade plastics and denser materials including rubber and metals.

12. A method of separating and recovering plastics from a mixed feedstock, the method comprising:
introducing the mixed feedstock into a gravity separation unit operated at a first specific gravity of about 1.0 to separate a heavier fraction from a lighter plastic fraction;
passing the lighter plastic fraction through a first screen having a selected opening size configured to liberate fibers and small debris;
conducting a first sink-float separation at a specific gravity of about 1.0 to separate low-density plastics from denser materials;
conducting a second sink-float separation at a specific gravity of about 1.15 to refine separation of acrylonitrile butadiene styrene (ABS) and polystyrene (PS) plastics from heavier contaminants;
processing plastic material through a vacuum pressure separator to separate light, mid-range, and heavy materials; and
applying friction separation to the mid-range materials to remove rubber and foam contaminants.

13. The method of claim 12, further comprising electrostatic sorting to distinguish high-grade plastic products including ABS, PS, and filled PP/PE materials.

14. The method of claim 12, wherein the mixed feedstock comprises automotive shredder residue (ASR).

15. The method of claim 12, wherein the first screen comprises a star screen having a gap smaller than an expected size of target material and a roof clearance of about 2 to 4 times the expected size of the target material to create vigorous agitation.

16. The method of claim 12, further comprising surface-drying plastic particles with a heated screw conveyor before the vacuum pressure separator.

17. The method of claim 12, further comprising mechanically cleaning the plastics in a ball mill without chemical treatment.

18. The method of claim 12, wherein a trommel-type screening unit removes small wire particulates and splinters from the plastic stream to increase material purity.

19. The method of claim 12, further comprising using a top pluck magnet to remove ferrous metals from the plastic stream before the surface-drying step.

20. The method of claim 12, wherein the first sink-float separation is performed at a specific gravity of about 1.0 such that polypropylene and polyethylene float and acrylonitrile butadiene styrene and polystyrene report with a sink fraction.

21. The method of claim 20, wherein the second sink-float separation is performed at a specific gravity between about 1.02 and about 1.25 to separate ABS and PS from filled polyolefin materials and other higher-density materials.

22. The method of claim 12, wherein the vacuum pressure separator separates super-light particles, mid-range plastics, and heavy contaminants into distinct material streams.

23. The method of claim 22, further comprising directing the mid-range plastics from the vacuum pressure separator to a friction separation device to remove rubber and foam contaminants.

24. The method of claim 23, further comprising conveying the mid-range plastics through a heated screw conveyor before friction separation to increase differential friction between plastic and contaminant components.

25. The method of claim 12, wherein an electrostatic sorting system distinguishes ABS, PS, and filled PP/PE products.

26. The method of claim 23, further comprising using an additional friction separator to ensure that high-grade plastics are substantially free of rubber and foam.

27. The method of claim 22, wherein the mid-range plastics obtained from the vacuum pressure separator are stored in protective silos before further use.

28. The method of claim 22, wherein the vacuum pressure separator utilizes aspiration to separate clean fuzz lights for reuse as absorbent cover or in landfill applications.

29. The method of claim 12, wherein the method is adapted for recycling commercial plastic waste and automotive shredder residue (ASR).

30. The method of claim 12, further comprising removing ferrous metal contaminants after the gravity separation step using a magnetic separator.

31. The method of claim 12, further comprising pelletizing or extruding the separated high-grade plastics for reuse in manufacturing.

32. A system for separating and recovering high-grade plastics from a mixed material feedstock, the system comprising:
a gravity separation unit operated at a specific gravity of about 1.0 to divide the feedstock into heavier and lighter fractions;
a screen configured to agitate the lighter fraction and liberate fibers and fine materials;
a shredder configured to reduce particle size and mechanically clean exterior surfaces of plastic particles;
a trommel-style screening unit configured to remove small debris, wire particulates, and splinters;
a first sink-float separation unit operated at a specific gravity of about 1.0 and a second sink-float separation unit operated at a specific gravity of about 1.15;
a vacuum pressure separator configured to separate light, mid-range, and heavy materials;
a friction separation device configured to remove rubber and foam contaminants from a mid-range plastic stream; and
an electrostatic sorting system configured to distinguish ABS, PS, and filled PP/PE materials.

33. The system of claim 32, further comprising a magnetic separator positioned upstream of the first sink-float separation unit and configured to remove ferrous metals from the feedstock.

34. The system of claim 32, wherein the screen comprises a star screen having a roof disposed above rotating stars at a clearance of about 2 to 4 times an expected size of target material, thereby agitating and impacting the lighter fraction for improved separation.

35. The system of claim 32, further comprising a heated screw conveyor configured to dry plastic particles before the vacuum pressure separator.

36. The system of claim 32, further comprising a top pluck magnet configured to remove iron from the feedstock.

37. The system of claim 32, further comprising a size-classification unit comprising a rotary drum screen or a vibratory screen configured to classify material into at least three size fractions and to discard particles smaller than about 1 mm as waste.

38. The system of claim 32, wherein the first sink-float separation unit is operated at a specific gravity of about 1.0 such that polypropylene and polyethylene float and denser plastics sink.

39. The system of claim 38, wherein the second sink-float separation unit is operated at a specific gravity of about 1.15 such that acrylonitrile butadiene styrene and polystyrene are separated from filled polyolefin materials or other composites.

40. The system of claim 39, wherein the friction separation device is configured to remove rubber and foam from the mid-range plastic stream to further purify acrylonitrile butadiene styrene and polystyrene materials.

41. A method for recovering plastic material from mixed waste material, comprising:
receiving a mixed waste feedstock comprising plastic and non-plastic material;
subjecting the mixed waste feedstock to a first density-based separation stage to produce a first plastic-enriched fraction and a first contaminant-enriched fraction;
reducing particle size of at least a portion of the first plastic-enriched fraction;
classifying the reduced material into size fractions;
conditioning at least one of the size fractions by removing moisture, fines, or both; and
subjecting conditioned material from the at least one size fraction to one or more downstream physical separation stages based on density, aerodynamic response, surface friction, electrical property, or a combination thereof to remove residual contaminants and recover at least one cleaned plastic product fraction.

42. The method of claim 41, wherein the first density-based separation stage comprises sink-float separation performed in a liquid medium at a selected specific gravity that causes lower-density plastic to report to one fraction and denser material to report to another fraction.

43. The method of claim 41, further comprising removing ferrous material from the mixed waste feedstock with a magnetic separator before or after the first density-based separation stage.

44. The method of claim 41, wherein the one or more downstream physical separation stages comprise vacuum-pressure separation that generates light, mid, and heavy fractions, and further comprise at least one of friction separation and electrostatic separation applied to at least a portion of the mid fraction.

45. A system for recovering plastic material from mixed waste material, comprising:
an input section configured to receive a mixed waste feedstock;
a first density-based separator configured to separate the feedstock into a first plastic-enriched fraction and a first contaminant-enriched fraction;
a size-reduction device arranged to receive at least a portion of the first plastic-enriched fraction;
a size-classification device configured to separate material from the size-reduction device into size fractions;
a conditioning section configured to remove moisture, fines, or both from at least one of the size fractions; and
one or more downstream separators configured to separate conditioned material from the at least one size fraction based on density, aerodynamic response, surface friction, electrical property, or a combination thereof and to output at least one cleaned plastic product fraction.

46. The system of claim 45, wherein the first density-based separator comprises a sink-float separator configured to operate at a selected specific gravity.

47. The system of claim 45, further comprising a magnetic separator positioned upstream or downstream of the first density-based separator.

48. The system of claim 45, wherein the one or more downstream separators comprise a vacuum-pressure separator configured to generate light, mid, and heavy fractions, and further comprise at least one of a friction separator and an electrostatic separator arranged to receive at least a portion of the mid fraction.
